(19) United States
(12) Patent Application Publication
(10) Pub. No.: US 2017/0083167 A1
(43) Pub. Date: Mar. 23, 2017

(54) PRESERVING FORM DATA IN BACKGROUND BROWSER TABS

(71) Applicant: Qualcomm Innovation Center, Inc., San Diego, CA (US)

(72) Inventors: Site Mao, San Diego, CA (US); Shyama Prasad Mondal, San Diego, CA (US); Kevin A. Hart, La Mesa, CA (US); Kulanthaivel Palanichamy, San Diego, CA (US)

(21) Appl. No.: 14/860,249

(22) Filed: Sep. 21, 2015

(51) Int. Cl. G06F 3/0481; G06F 17/24

(52) U.S. Cl. CPC G06F 3/0481; G06F 17/243

(57) ABSTRACT

A method and apparatus for retaining background tab form data on a browser are disclosed. The method may include maintaining a plurality of browser tabs and initiating an exit from a particular one of the plurality of browser tabs. Form data from the particular one of the plurality of browser tabs is stored before the particular one of the plurality of browser tabs is exited, and then the particular one of the plurality of browser tabs is exited. The particular one of the plurality of browser tabs is restarted in response to a user request, and the form data within the particular one of the plurality of browser tabs is restored.

### TECHNICAL FIELD

The present invention relates to portable computing devices. In particular, but not by way of limitation, the present invention relates to storage and usage of user content on portable computing devices.

### BACKGROUND

Advances in technology have allowed for the use and development of electronic computing devices. Currently, these devices are able to access online servers and network data through multiple wireless methods including satellite signals, Wi-Fi hotspots, or Bluetooth tethering connections. This data access is streamlined and made user friendly via the use of Internet Browsers. Furthermore, these devices are currently able to submit and upload user content to many online servers through e-mail, online forums, blog websites, social media websites and many more. This user content is often actualized by the end-user, via an Internet browser, by filling out forms, or form data, to be submitted to the website.

Many Internet browsers capable of generating and submitting such form data allow for access to multiple websites or online servers at one given time. These connections are typically organized, via Internet browsers, through multiple user interface windows, or tabs. Currently, many portable computing devices utilize tabs for end-user convenience. Due to memory limitations (e.g., on portable computing devices), tabs that are out of use, or background, will often sever their connections to the websites or servers and delete any associated form data that had not been submitted to the website.

As a result, neglected form data on portable devices may disappear at the dismay of an end-user. Thus, retaining the form data on background tabs, without exceeding the portable device's memory limitations, is desired to improve user content submission and use on portable computing devices.

### SUMMARY

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

One aspect may be characterized as a method for retaining background tab form data on a browser of a computing device. The method may include maintaining a plurality of active browser tabs, each of the active browser tabs including data stored in memory of the computing device corresponding to one of a plurality of webpages. When an exit from a particular one of the plurality of browser tabs is initiated, form data from the particular one of the plurality of browser tabs is stored before the particular one of the plurality of browser tabs is exited. When the particular one of the plurality of browser tabs is restarted in response to a user request, the form data within the particular one of the plurality of browser tabs is restored.

Another aspect may be characterized as a computing device that includes a transceiver to send requests for webpages and receive webpage data. The computing device includes a user interface to receive form data entered by a user in connection with at least one of the webpages and non-volatile memory to store the form data. A browser is configured to display each of the webpages in a corresponding one of a plurality of tabs, and the browser includes a browser memory monitor configured to limit a number of active browser tabs to a threshold number. Each of the active browser tabs have a corresponding process running on the computing device, and the browser memory monitor exits a particular active browser tab to generate an inactive browser tab when the number of active browser tabs exceeds the threshold number. The computing device also includes a form data renderer that is configured to store form data from a particular active browser tab in the non-volatile memory before the browser memory monitor exits the particular active browser tab and restore the form data in a form of a webpage of the inactive browser tab when the inactive browser tab is restarted.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings in which like or similar elements are designated with identical reference numerals throughout the several views, and wherein:

FIG. 1. is a functional block diagram depicting components of a portable computing device in accordance with aspects of the present invention.

FIG. 2. is a flowchart illustrating steps that may be taken by both a system level and user interface level according to one embodiment of the invention.

FIG. 3 is a block diagram of an exemplary portable computing device that can facilitate preserving form data according to an aspect of the invention.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Users of computing devices (such as desktop computers, laptop computers, table computers, and smartphones) are accustomed to opening multiple website tabs in web browsers, and possibly leaving the tabs open for substantial periods of time. Sometimes a user leaves tabs open inadvertently, and simply forgets to close them, and sometimes the user leaves them open for ease of access to the website or certain information generated from the website. Typically, a user has one “current,” “main,” or “foreground” page open in a particular browser, which, for the purposes of this disclosure, refers to the webpage that is actually displayed or interacted with by the user. Any previously opened webpages that the user has not closed are referred to as active “background webpages” (or alternatively, active background “tabs,” “pages,” or “sites”). These active background tabs are “active” in the sense that each of the active tabs has a render process that resides in memory (e.g., RAM) and is executed by processing resources of the computing device so that these active background tabs may be quickly displayed if they are brought to the foreground by the user. Aspects of this disclosure may be implemented in any Internet browser that supports multiple tabs.

In environments where memory, network bandwidth, power consumption, and processing power are not greatly constrained, such as a powerful desktop computer, maintaining multiple active background tabs may not be problematic. A user may be able to keep multiple active background tabs open and readily available, without any noticeable loss in performance on the device or on the browser. However, in different computing environments with more constraints, such as on a smartphone or tablet computer running on a battery, active background tabs can be costly in terms of battery power, processing power, network data transmission, and memory availability.

As a result, many browsers will exit or “kill” the active background webpage so the rendering process for the active background tab is no longer executing (e.g., neither occupying memory nor being processed by a processor) leaving only a snapshot (alternatively referred to as an inactive background tab, thumbnail, or a placeholder) of the website available in the background Killing (also referred to as exiting) active background websites can be inconvenient for a user for multiple reasons, including that the killed website must be completely refreshed when the user decides to go back to a placeholder tab for the website, which may take an undesirable amount of time. And as discussed above, the loss of form data when an active background tab is exited may be very frustrating for a user.

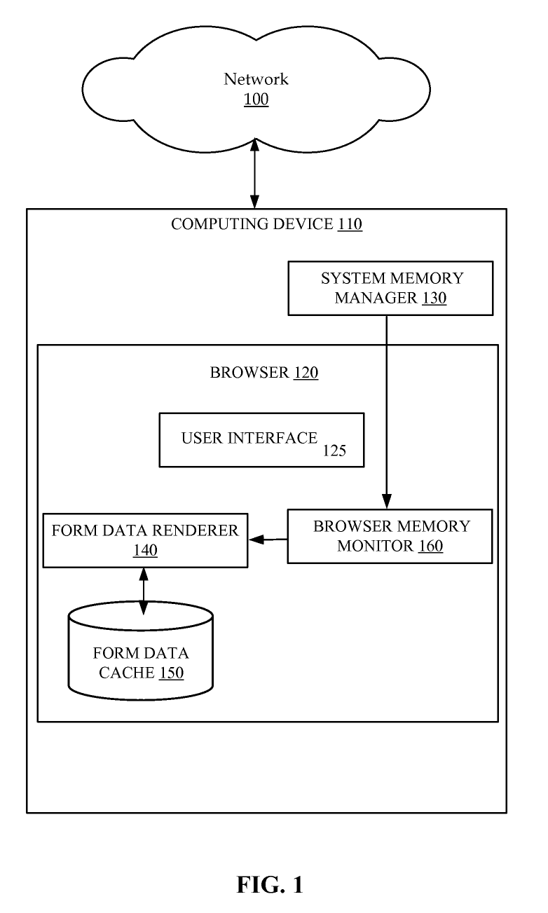

Referring to FIG. 1, shown is an exemplary illustration of a portable computing device 110 coupled to a network 100 according to an embodiment of the present invention. As shown, the computing device 110 contains a browser 120 and a system memory manager 130. And the browser 120 includes a user interface 125 and form data renderer 140 that is in communication with both a form data cache 150 and a browser memory monitor 160. The browser 120 is also connected to the system memory manager 130 via the browser memory monitor 160.

The computing device 110 may be realized by a wireless communications device such as a smartphone, PDA, netbook, tablet, laptop computer and other wireless devices. But the computing device 110 may work in tandem with wireline and wireless communication devices. The network 100 may include the Internet, local area networks, cellular networks (e.g., CDMA, GPRS, and UMTS networks), WiFi networks, and other types of communication networks.

One of ordinary skill will appreciate that the depicted computing device 110 is capable of retrieving and sending data to a network 100. The received data, for example, may include website information that is served up from one or more remote servers, and the data that is sent from the computing device 110 may include form data that is submitted from the computing device 110 to a remote server via the network 100.

One of ordinary skill will also appreciate that FIG. 1 is a simplified representation of the computing device 110 that does not show many other well-known components to provide clarity. For example, the browser 120 may include a browser core that generally operates to parse, render, and composite webpage content for presentation to the user of the computing device 110. In some embodiments for example, the browser core may be realized by a WebKit browser core, but this is certainly not required and other types of browser cores may be utilized. Additionally, it may be appreciated by one of ordinary skill in the art that the depicted functional components, and other constituent elements may be actualized through numerous variations of hardware and hardware in connection with software.

In general, the browser 120 enables a user, via the user interface 125, to request content from any of a multitude of remote servers that are in communication with the computing device 110 via the network 100, which may be realized by the Internet and a combination of local and wide area networks. In many instances, the content from the remote servers is served up as webpages, which the browser 120 displays via the user interface 125. The browser 120 also enables multiple webpage tabs to be opened, and the user may interact with the webpage in the foreground while other active and inactive tabs reside in the background.

Many webpages are constructed to include forms that are unique by virtue of the unique content requested in each field and/or the unique order of the fields in the forms. Also some forms (e.g., forms in a webpage forum) allow users to create and place original (e.g., unique), and sometimes lengthy, expressive content in fields. This type of form data is not readily reproducible, and it should be recognized that this original, unique, or very infrequently used form data is in contrast to frequently reused form data, such as, the user's name, address, and credit card information, which may be reproduced easily for the user.

As discussed above, users are prone to jumping from one browser tab to another—often leaving incomplete or unsent original, unique, or rarely used form data in a browser tab. When this incomplete or unsent form data is left in a particular background tab (while the user opens other new tabs) the particular background tab may be exited so that the render process associated with the particular background tab no longer demands resources (e.g., memory or processing resources). In prior typical browsers, to the dismay of the user, the user must recreate the original, unique, or rarely used form data.

In the present embodiment, the form data renderer 140 functions to cache the form data (in the form data cache 150) that the user has entered (or selected via displayed buttons) before the tab is rendered inactive (e.g., before the rendering process tab associated with the tab is destroyed or exited). More specifically, the form data renderer 140 is disposed to receive a signal (e.g., a low memory signal) from the browser memory monitor 160 before the browser memory monitor 160 prompts the exiting of the browser tab, and in response, the form data renderer 140 stores the form data in the form data cache 150. Once exited, the tab may remain as an inactive placeholder tab (that does not have an associated rendering process) to enable the user to reload and redraw the webpage. When the user reloads and redraws the webpage, the form data renderer 140 repopulates the form of the webpage with the stored form data.

In general, the browser memory monitor 160 operates to limit the resource-consumptive effects of multiple active tabs in the background by prompting the exiting of one or more background tabs before the active background tab(s) adversely affect performance of the computing device 110. In some implementations for example, the browser memory monitor 160 is configured to exit or destroy a background browser tab when the number of active background tabs exceeds a threshold number of background tabs. For example, the threshold may be a maximum number of active background tabs (e.g., three background tabs).

In some variations, the maximum number of active background tabs may be a tunable parameter so that the maximum number of background browser tabs may be set to two, three, four, five, six or more browser tabs. In these variations, the maximum number of active background tabs that are allowed may be set by the user, or may be determined based upon memory utilization information from the system memory manager 130.

In many implementations, the system memory manager 130 is optional, but in general the system memory manager 130 operates to “observe” utilization of a memory (e.g., random access memory (RAM)) of the computing device 110 and provide information about the status of the memory utilization to the browser memory monitor 160. The browser memory monitor 160 may then use this memory utilization information to adjust the threshold number of maximum active background tabs. For example, in response to other applications using an increased amount of memory, the system memory manager 130 may provide a low memory indication to the browser memory monitor 160, and in response, the browser memory monitor 160 may adjust the maximum number of allowed active background tabs (e.g., from three active background tabs to two active background tabs).

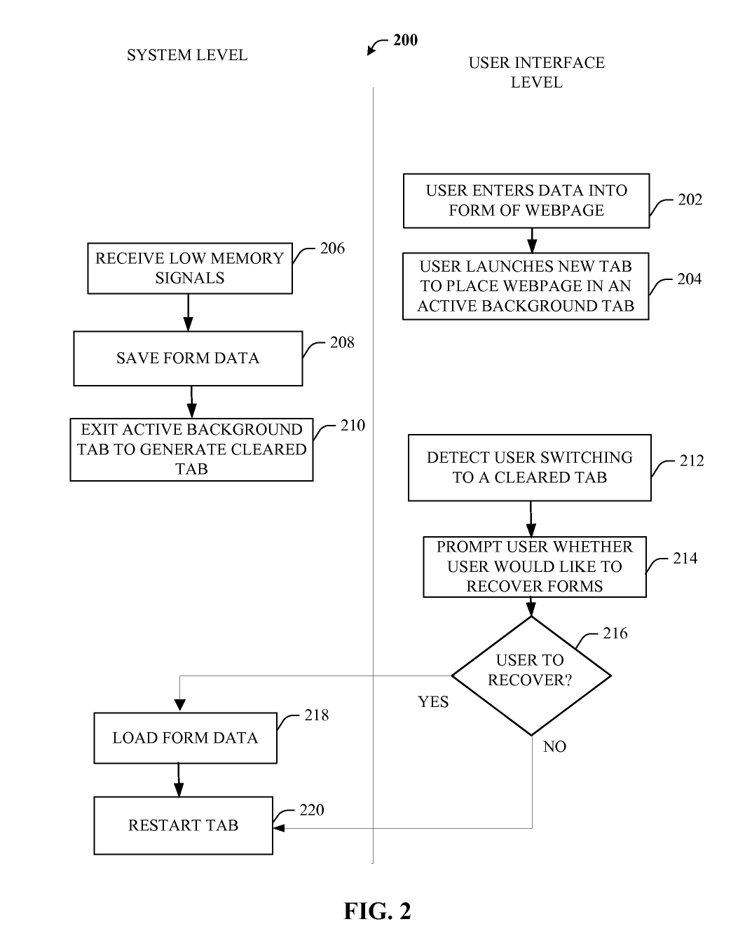

Referring to FIG. 2, shown is a flowchart depicting a method that may be traversed in connection with embodiments disclosed herein. As shown, when interacting with a webpage displayed by the browser 120, a user may enter form data into that webpage via the user interface 125 of the browser 120 (Block 202). As discussed above, a user may then open a new tab to browse to a new webpage, which places the initial webpage in an active background tab (Block 204). To reiterate, “active” here means a rendering process associated with the background tab is maintaining the background tab active, which utilizes memory and requires a processor to execute instructions associated with the active background tab.

As shown, memory utilization of tasks on the computing device 110 may prompt the browser memory monitor 160 to initiate a low memory signal (Block 206), and in turn, the form data renderer 140 may save the form data of the background tab in the form data cache (Block 208). As discussed above, if the number of active browser tabs (e.g., a total number of active foreground and background tabs) reaches a threshold number, the browser memory monitor 160 may send a low memory signal to the form data renderer 140. And in some embodiments, the system memory manager 130 may send a signal indicative of memory utilization to the browser memory monitor 160, which may prompt the browser memory monitor 160 to adjust the threshold maximum number of allowable active browser tabs. As shown, in response to the low memory signal (Block 206), the active background tab with the form data is cleared leaving a cleared place holder tab (Block 210)

When the user switches to the cleared background tab (Block 212), the user may optionally be prompted as to whether the user would like to recover the stored form data that was cleared from the background tab (Block 214). If the user desires to recover the form data (Block 216), the form data renderer 140 loads the form data from the form data cache 150 (Block 218), and the cleared tab is restarted (Block 220). If the user does not desire to recover the form data (Block 216), then the cleared background tab is launched (Block 220) without loading the form data (Block 218).

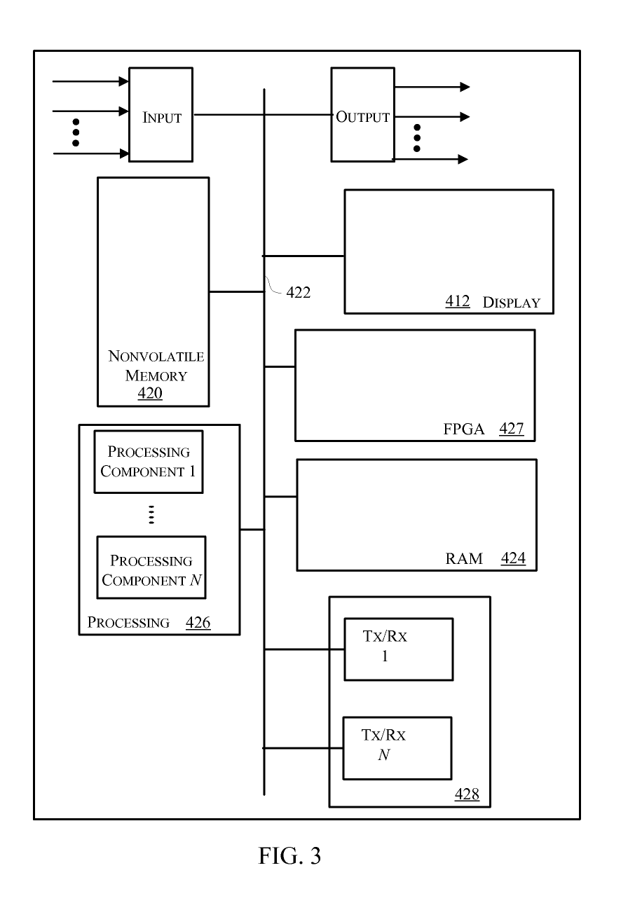

Referring next to FIG. 3, shown is a block diagram depicting physical components that may be utilized to realize one or more aspects of the embodiments disclosed herein. As shown, in this embodiment a display portion 412 and nonvolatile memory 420 are coupled to a bus 422 that is also coupled to random access memory (“RAM”) 424, a processing portion (which includes N processing components) 426, a field programmable gate array (FPGA) 427, and a transceiver component 428 that includes N transceivers. Although the components depicted in FIG. 3 represent physical components, FIG. 3 is not intended to be a detailed hardware diagram; thus many of the components depicted in FIG. 3 may be realized by common constructs or distributed among additional physical components. Moreover, it is contemplated that other existing and yet-to-be developed physical components and architectures may be utilized to implement the functional components described with reference to FIG. 3.

This display 412 generally operates to provide a user interface for a user. The display 412 may be realized, for example, by an LCD or AMOLED display, and in several implementations, the display 412 is realized by a touchscreen display. The display 412 may be utilized to realize, in part, the user interface 125, provided by the browser 120. In general, the nonvolatile memory 420 is non-transitory memory that functions to store (e.g., persistently store) data and processor executable code (including executable code that is associated with effectuating the methods described herein). In some embodiments for example, the nonvolatile memory 420 includes bootloader code, operating system code, file system code, and non-transitory processor-executable code to facilitate the execution of the methods described herein including the method described with reference to FIG. 2. Moreover, the non-volatile memory may be utilized to realize the form data cache 150 described with reference to FIG. 1.

In many implementations, the nonvolatile memory 420 is realized by flash memory (e.g., NAND or ONENAND memory), but it is contemplated that other memory types may be utilized as well. Although it may be possible to execute the code from the nonvolatile memory 420, the executable code in the nonvolatile memory is typically loaded into RAM 424 and executed by one or more of the N processing components in the processing portion 426.

The N processing components in connection with RAM 424 generally operate to execute the instructions stored in nonvolatile memory 420 to enable the loading and rendering of webpages and form data associated with such webpages. For example, non-transitory processor-executable instructions to effectuate the methods described with reference to FIG. 2 may be persistently stored in nonvolatile memory 420 and executed by the N processing components in connection with RAM 424. As one of ordinarily skill in the art will appreciate, the processing portion 426 may include a video processor, digital signal processor (DSP), graphics processing unit (GPU), and other processing components.

In addition, or in the alternative, the FPGA 427 may be configured to effectuate one or more aspects of the methodologies described herein (e.g., the methods described with reference to FIG. 2). For example, non-transitory FPGA-configuration-instructions may be persistently stored in nonvolatile memory 420 and accessed by the FPGA 427 (e.g., during boot up) to configure the FPGA 427 to effectuate functions of one or more of the components depicted in FIG. 1 including the form data renderer 140.

The depicted transceiver component 428 includes N transceiver chains, which may be used for communicating with external devices via wireless or wireline networks. Each of the N transceiver chains may represent a transceiver associated with a particular communication scheme (e.g., WiFi, CDMA, Bluetooth, NFC, etc.). The transceiver chains may be utilized to request and receive webpages and send form data as described herein.

What is claimed is:

1. A method for retaining background tab form data on a browser of a computing device, the method comprising:
maintaining a plurality of browser tabs, each of the browser tabs associated with data stored in memory of the computing device corresponding to one of a plurality of webpages;
initiating an exit from a particular one of the plurality of browser tabs;
storing form data from the particular one of the plurality of browser tabs before the particular one of the plurality of browser tabs is exited;
exiting the particular one of the plurality of browser tabs to generate an inactive background tab;
restarting the particular one of the plurality of browser tabs in response to a user request;
restoring the form data within the particular one of the plurality of browser tabs.

2. The method of claim 1, including:
initiating the exit from the particular one of the plurality of browser tabs when a threshold number of browser tabs is exceeded.

3. The method of claim 2, wherein the threshold number of browser tabs that may be maintained is determined by a low memory signal from the system memory manager.

4. The method of claim 1, wherein initiating the exit from the particular one of the plurality of browser tabs is prompted by a low memory signal.

5. The method of claim 1, including:
prompting a user, before restoring the form data, whether to restore the form data within the particular one of the plurality of browser tabs.

6. A computing device comprising:
a transceiver to send requests for webpages and receive webpage data;
a user interface to receive form data entered by a user in connection with at least one of the webpages;
non-volatile memory to store the form data;
a browser configured to display each of the webpages in a corresponding one of a plurality of tabs, the browser including:
a browser memory monitor configured to limit a number of active browser tabs to a threshold number, each of the active browser tabs having a corresponding process running on the computing device, the browser memory monitor exiting a particular active browser tab to generate an inactive browser tab when the number of active browser tabs exceeds the threshold number;
a form data renderer, configured to:
store form data from a particular active browser tab in the non-volatile memory before the browser memory monitor exits the particular active browser tab; and
restore the form data in a form of a webpage of the inactive browser tab when the inactive browser tab is restarted.

7. The computing device of claim 6, wherein the form data renderer prompts the user, before restoring the form data, whether the user wants to restore the form data.

8. The computing device of claim 6, including a system memory manager that provides an indication of memory utilization on the computing device, wherein the browser memory manager adjusts the threshold number in response to the indication of memory utilization.

9. A non-transitory, tangible processor readable storage medium, encoded with processor readable instructions to perform a method for retaining background tab form data on a browser of a computing device, the method comprising:
maintaining a plurality of browser tabs, each of the browser tabs associated with data stored in memory of the computing device corresponding to one of a plurality of webpages;
initiating an exit from a particular one of the plurality of browser tabs;
storing form data from the particular one of the plurality of browser tabs before the particular one of the plurality of browser tabs is exited;
exiting the particular one of the plurality of browser tabs to generate an inactive background tab;
restarting the particular one of the plurality of browser tabs in response to a user request;
restoring the form data within the particular one of the plurality of browser tabs.

10. The non-transitory, tangible processor readable storage medium of claim 9, including:
initiating the exit from the particular one of the plurality of browser tabs when a threshold number of browser tabs is exceeded.

11. The non-transitory, tangible processor readable storage medium of claim 10, wherein the threshold number of browser tabs that may be maintained is determined by a low memory signal from the system memory manager.

12. The non-transitory, tangible processor readable storage medium of claim 9, wherein initiating the exit from the particular one of the plurality of browser tabs is prompted by a low memory signal.

13. The non-transitory, tangible processor readable storage medium of claim 9, including:
prompting a user, before restoring the form data, whether to restore the form data within the particular one of the plurality of browser tabs.
